(19) United States
(12) Patent Application Publication
(10) Pub. No.: US 2006/0240895 A1
(43) Pub. Date: Oct. 26, 2006

(54) Constant velocity universal joint and outer race thereof

(75) Inventors: Shogo Yamano, Aichi-gun (JP); Takeo Yamamoto, Nisshin-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 11/395,206

(22) Filed: Apr. 3, 2006

(30) Foreign Application Priority Data
Apr. 20, 2005 (JP) 2005-122431

(51) Int. Cl. F16D 3/34

(52) U.S. Cl. 464/145

(57) ABSTRACT

A Birfield joint with an increased angle is provided. The joint includes an outer race having a root portion connected to a shaft and an opening portion receiving a counterpart member. A groove is formed at the outer race so as to extend from the root portion to the opening portion. The joint further includes a ball that can roll along the groove and that contacts to the groove at a contact. The groove is formed such that a contact angle is smaller as nearer to the opening portion away from the root portion.

This nonprovisional application is based on Japanese Patent Application No. 2005-122431 filed with the Japan Patent Office on Apr. 20, 2005, the entire contents of which are hereby incorporated by reference.

### BACKGROUND OF THE INVENTION

1. Field of the Invention

The present invention relates to a constant velocity universal joint and an outer race, and particularly, to a Birfield joint with an increased rotation angle (rocking angle) and to an outer race thereof

2. Description of the Background Art

Conventionally, a Birfield joint is disclosed in Japanese Patent Laying-Open No. 07-317791 (Reference 1), for example.

Reference 1 discloses a technique for preventing balls from being displaced from a cage and for increasing an operation angle, by providing a groove to an inner race which allows a ball positioned on the outer race opening side to have a greater clearance between the outer race than the other balls have.

However, the shape of a conventional Birfield joint is determined so that a shaft and a taper portion of the end surface of an outer race interferes with each other and that the contact between a ball and a ball groove is secured. According to a conventional technique, when a rotation angle (rocking angle, joint angle) of at least 50° is set, there has been a problem that either the shaft interferes or the ball leaves the contact point and the function as a joint is lost.

### SUMMARY OF THE INVENTION

Accordingly, the present invention has been made to solve such a problem, and an object thereof is to provide a constant velocity universal joint with an increased joint angle and an outer race thereof

A constant velocity universal joint according to the present invention includes an outer race having a root portion connected to a rotator and an opening portion receiving a counterpart member. A groove is formed at the outer race so as to extend from the root portion to the opening portion. The constant velocity universal joint further includes a ball that can roll along the groove and that contacts to the groove at a contact. At the opening portion, a taper surface is formed where an end surface of the outer race can abut against the counterpart member. The groove is formed such that a contact angle formed between a line connecting a center of the groove and a center of the ball and a line connecting the contact and the center of the ball is smaller as nearer to the opening portion away from the root portion.

With the constant velocity universal joint thus structured, since the groove is formed such that a contact angle is smaller as nearer to the opening portion away from the root portion, at the opening portion, the ball and the groove contact to each other near the bottom of the groove. As a result, a greater taper surface can be provided, and the rotation angel can be increased.

An outer race of a constant velocity universal joint according to the present invention has a root portion connected to a rotator and an opening portion receiving a counterpart member. A groove is formed at the outer race so as to extend from the root portion to the opening portion. A ball can roll along the groove and the ball contacts to the groove at a contact. At the opening portion, a taper surface is formed where an end surface can abut against the counterpart member. The groove is formed such that a contact angle formed between a line connecting a center of the groove and a center of the ball and a line connecting the contact and the center of the ball is smaller as nearer to the opening portion away from the root portion.

With the outer race of a constant velocity universal joint thus structured, since the groove is formed such that a contact angle is smaller as nearer to the opening portion away from the root portion, at the opening portion, the ball and the groove contact to each other near the bottom of the groove. As a result, a greater taper surface can be provided, and the rotation angel can be increased.

According to the present invention, a constant velocity universal joint with an increased angle can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a side view including a partial cutaway view of a Birfield joint according to the present invention.

FIG. 2 is a cross-sectional view showing an enlarged outer race in FIG. 1.

FIG. 3 is a cross-sectional view along line III-III in FIG. 2.

FIG. 4 is a cross-sectional view along line IV-IV in FIG. 2.

FIG. 5 is a graph showing the relationship between the contact angle and the joint maximum angle.

FIG. 6 is a side view including a partial cutaway view of a drive line to which a Birfield joint according to the present invention is applied.

FIG. 7 is a cross-sectional view of a hub apparatus to which a Birfield joint according to the present invention is applied.

### DESCRIPTION OF THE PREFERRED EMBODIMENTS

In the following, an embodiment of the present invention is described referring to the drawings. In the following embodiment, the same or corresponding parts are denoted by the same reference characters, and description thereof is not repeated.

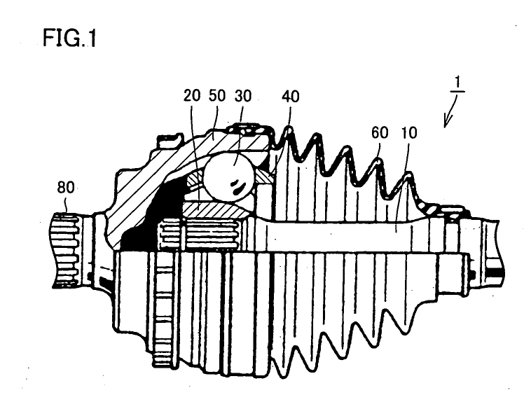

FIG. 1 is a side view including a partial cutaway view of a Birfield joint according to an embodiment of the present invention. Referring to FIG. 1, a Birfield joint 1 as a constant velocity universal joint includes a shaft 10, an inner race 20 that is spline-fitted to shaft 10, a ball 30 contacting to inner race 20, a cage 40 holding ball 30, an outer race 50 contacting to ball 30, a boot 60 covering inner race 20, ball 30 and outer race 50, and a shaft 80 connected to outer race 50.

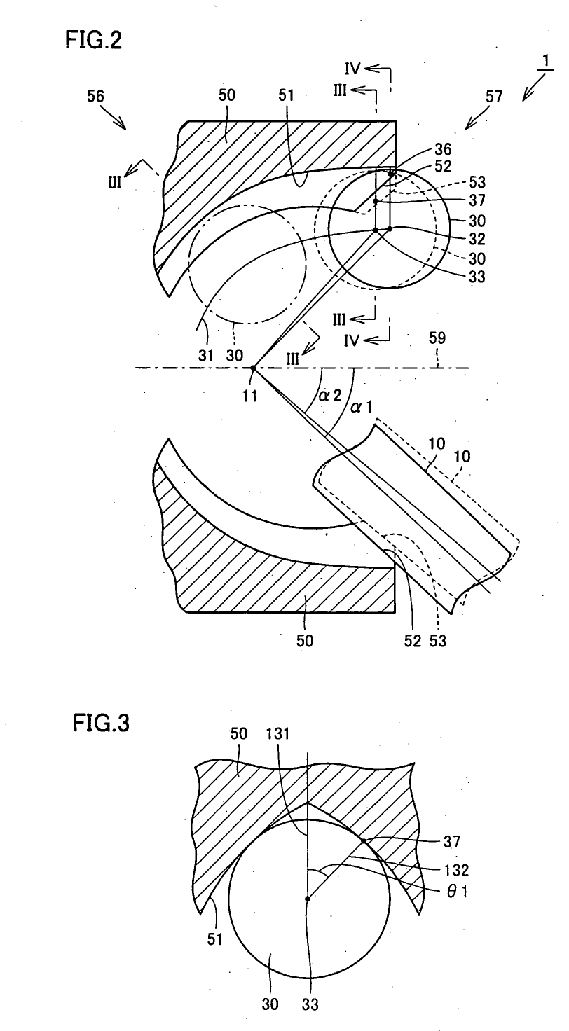

FIG. 2 is a cross-sectional view showing an enlarged outer race in FIG. 1. Referring to FIG. 2, outer race 50 has a groove 51 extending from a root portion 56 to an opening portion 57 that is a mouth portion, and ball 30 is fitted into groove 51. The groove of Birfield joint 1 may be part of an arc (BJ) or it may be a straight line having a slope of at most 1° relative to an axis (UBJ). Ball 30 can roll in groove 51, and grease is applied inside groove 51 in order to reduce the resistance in rolling.

An end surface 52 that is a taper surface is provided on an opening portion 57 side of Birfield joint 1, and shaft 10 and end surface 52 contact to each other with their surfaces. End surface 52 is shaped as a circular conical surface.

In Birfield joint 1, a plurality of balls 30 intervene between outer race 50 and inner race 20. The plurality of balls 30 are arranged on a plane that equally divides an angle formed between a rotation axis of outer race 50 and a rotation axis of inner race 20. Groove 51 for holding balls 30 is provided to outer race 50. Groove 51 extends from one end on the side near a shaft 80 to which outer race 50 is attached to the other end on the side away from shaft 80. The contact angle between ball 30 and groove 51 is smaller as nearer to the other end. On the other end side, end surface 52 that is a taper surface conforming to shaft 10 attached to inner race 20 is provided.

Ball 30 has its center 32, of which track is a center track 31. A contact point 36 between ball 30 and groove 51 is positioned near opening portion 57, which is near end surface 52. Ball 30 can move in groove 51 as indicated by a double dashed line. The shape of end surface 52 determines the rotation angle of shaft 10. The shape indicated by a solid line in FIG. 2 is an outer shape of the product of the present invention, and the shape indicated by a dashed line is an outer shape of a conventional product. In opening portion 57, contact point 36 is provided at a shallow position according to the present invention, whereby end surface 52 is shaped to be deeply cut. Thus, rotation angle α relative to a center axis 59 (rotation axis) of outer race 50 is increased. As indicated by the dashed line, a contact 37 of conventional ball 30 and the groove is positioned nearer to rotation center 11, as compared to contact 36 of the present invention. Accordingly, an end surface 53 that is a taper surface is not formed to be cut deeply and the portion contacting to end surface 53 corresponds to the rotation angle of shaft 10, whereby rotation angle α2 becomes smaller than rotation angle α1.

FIG. 3 is a cross-sectional view along line III-III in FIG. 2. Referring to FIG. 3, a contact angle θ1 in a conventional product is for example 30°-50°. Contact angle θ1 is formed between a line 131 connecting center 33 of ball 30 and the center of groove 51 and a line 132 connecting contact 37 and center 33 of ball 30. It is noted that ball 30 indicated by a double dashed line in FIG. 2 also provides contact angle θ1 as in FIG. 3. In other words, near a central cross section indicated by a double dashed line, the contact angle is set to 30°-50° in the light of ensuring durability.

The product according to the present invention and the conventional product are not different in the shape of the groove near root portion 56 indicated by the double dashed line.

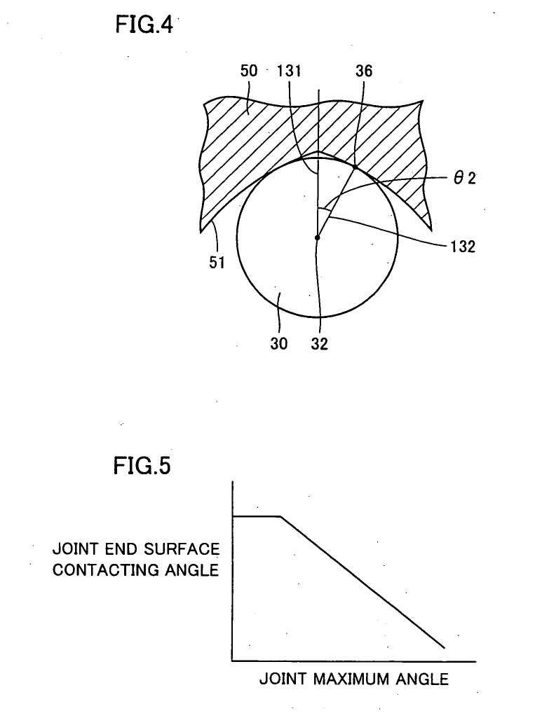

FIG. 4 is a cross-sectional view along line IV-IV in FIG. 2. Referring to FIG. 4, contact angle θ2 of the product according to the present invention is smaller than contact angle θ1 of the conventional product shown in FIG. 3. Therefore, end surface 52 that is a taper surface moves toward root portion 56, whereby rotation angle α can further be increased. The diameter of shaft 10 is φ. That is, decreasing the contact angle from the angle shown in FIG. 3 to the angle shown in FIG. 4 according to the present invention, contact point 37 shifts to contact point 36. Thus, the bevel end surface of outer race 50 necessary for securing the contact point can be changed from end surface 53 to end surface 52, and therefore the interference of shaft 10 can be prevented and the rotation angle can be increased from α2 to α1.

FIG. 5 is a graph showing the relationship between the contact angle and the joint maximum angle. Referring to FIG. 5, decreasing the contact angle, the joint maximum angle (α) can be increased. The slope in FIG. 5 is determined by the balance in the specification of the joint. That is, the maximum angle can be adjusted in accordance with the durability, the required specification and the like of Birfield joint 1.

Near opening portion 57 that is a mouth portion, the contact angle attains the possible smallest angle in the shape capable of securing the contact. The contact angle becomes gradually smaller as nearer to opening portion 57 away from root portion 56, and attains the smallest value (substantially 0°) around end surface 52.

Birfield joint 1 according to the present invention has outer race 50 having root portion 56 connected to shaft 80 as a rotator and opening portion 57 for receiving shaft 10 as a counterpart member. Groove 51 is formed at outer race 50 so as to extend from root portion 56 to opening portion 57. Birfield joint 1 further includes a ball 30 that can roll along groove 51 and that contacts to groove 51 at contact 36. At opening portion 57, a taper surface is formed where end surface 52 of outer race 50 can abut against shaft 10. Groove 51 is formed such that a contact angle θ2 formed between a line 131 connecting a center of groove 51 and center 32 of ball 30 and line 132 connecting contact 36 and center 32 of ball is smaller as nearer to opening portion 57 away from root portion 56.

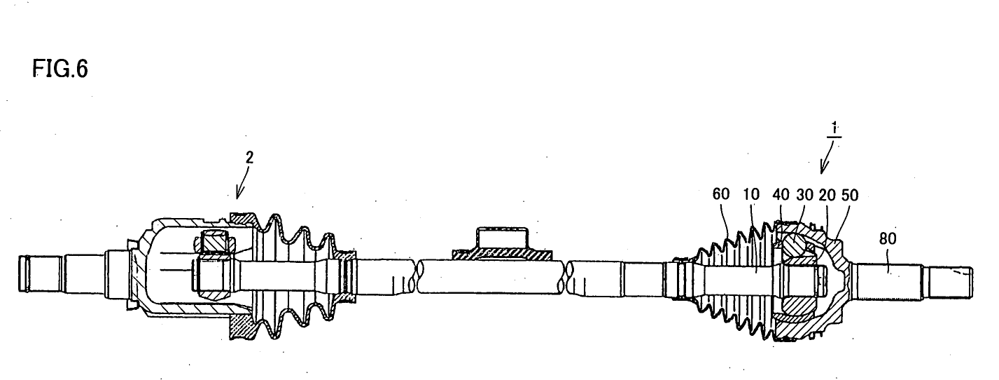

FIG. 6 is a side view including a partial cutaway view of a drive line to which a Birfield joint according to the present invention is applied. Referring to FIG. 6, Birfield joint 1 according to the present invention may be used in driving wheels of a vehicle, for example. FIG. 6 shows a structure where Birfield joint 1 and a tripod joint 2 are connected via shaft 10. Specifically, the output of the engine is transmitted to tripod joint 2, and the output of tripod joint 2 is transmitted to Birfield joint 1 via shaft 10. Shaft 80 connected to outer race 50 of Birfield joint 1 is connected to the steering wheel. As the rocking angle (rotation angle) of Birfield joint 1 increases, the angle of tires attached to shaft 80 being steered (steering angle) increases. Additionally, along with Birfield joint 1 being shifted in upward/downward direction, tripod joint 2 slides in the axial direction and the length thereof changes.

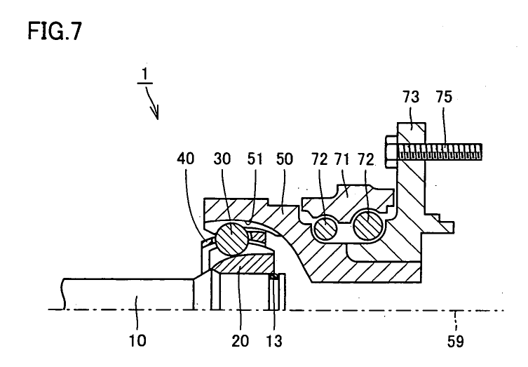

FIG. 7 is a cross-sectional view of a hub apparatus to which a Birfield joint according to the present invention is applied. Referring to FIG. 7, outer race 50 contacts to hub 73, and a hub bolt 75 penetrates through hub 73. Outside hub 73 and outer race 50, ball 72 is arranged, and ball 72 is held by outer race 71. A wheel is attached to hub bolt 75 of hub 73. The load transmitted from the wheel is held at outer race 71 via ball 72. Birfield joint 1 has an outer race 50, a ball 30 contacting to groove 51 of outer race 50, a cage (holding device) holding ball 30, an inner race 20 contacting to ball 30, a shaft 10 being a rotation center of inner race 20, and a snap ring 13 for fixing inner race 20 to shaft 10.

With the Birfield joint 1 thus structured, as the contact angle is smaller as nearer to opening portion 57 that is a mouth, the taper shape can be made great, and the rocking angle can be increased. The embodiment of the present invention which has been described in the foregoing can be modified in various ways. First, the Birfield joint constituting the present invention is only necessary to be provided as a part of the drive line, and it may not necessarily be provided to the steering wheel. For example, the drive shaft and outer race 50 may be connected, and inner race 20 and the side gear of the differential gear may be connected. Conversely, outer race 50 may be connected to the side gear of the differential gear, and inner race 20 may be connected to the drive shaft.

Further, the configuration of the present invention is not limited to the Birfield joint, and it is applicable to a constant velocity universal joint of which rotation angle is determined by the contact between end surface 52 and shaft 10.

Still further, inner race 20 may be connected to the input shaft of the differential gear, and outer race 50 may be connected to the propeller shaft inputting power to the differential gear. Conversely, outer race 50 may be connected to the input shaft of the differential gear, and inner race 20 may be connected to the propeller shaft.

Still further, Birfield joint 1 according to the present invention may be applied to the input portion of a power transfer (transfer).

Still further, while outer race 50 is provided on the hub side in the hub apparatus shown in FIG. 7, inner race 20 may conversely be provided to be connected to hub 73 and shaft 10 and outer race 50 may be connected to each other.

The present invention is for example applicable to the field of a drive line of a vehicle.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A constant velocity universal joint, comprising:
an outer race having a root portion connected to a rotator and an opening portion receiving a counterpart member, a groove being formed at said outer race so as to extend from said root portion to said opening portion, and
a ball that can roll along said groove and that contacts to said groove at a contact, wherein
at said opening portion, a taper surface is formed where an end surface of said outer race can abut against said counterpart member, and
said groove is formed such that a contact angle formed between a line connecting a center of said groove and a center of said ball and a line connecting said contact and said center of said ball is smaller as nearer to said opening portion away from said root portion.

2. The constant velocity universal joint according to claim 1, further comprising
a cage holding a plurality of said balls.

3. The constant velocity universal joint according to claim 1, further comprising
an inner race contacting to the plurality of said balls, wherein
the plurality of said balls intervene between said inner race and said outer race.

4. The constant velocity universal joint according to claim 1, wherein
said taper surface is shaped as a circular conical surface.

5. An outer race of a constant velocity universal joint having a root portion connected to a rotator and an opening portion receiving a counterpart member, a groove being formed at said outer race so as to extend from said root portion to said opening portion, wherein
a ball can roll along said groove and said ball contacts to said groove at a contact,
at said opening portion, a taper surface is formed where an end surface can abut against said counterpart member, and
said groove is formed such that a contact angle formed between a line connecting a center of said groove and a center of said ball and a line connecting said contact and said center of said ball is smaller as nearer to said opening portion away from said root portion.
